(19) United States
(12) Patent Application Publication
(10) Pub. No.: US 2026/0289454 A1
(43) Pub. Date: Sep. 24, 2026

(54) Personalized Text-to-Action with Domain Knowledge

(71) Applicant: ServiceNow, Inc., Santa Clara, CA (US)

(72) Inventors: Orlando Edson Marquez Ayala, Montreal (CA); Jing Fei Chen, San Francisco, CA (US); Patrice Béchard, Verdun (CA)

(21) Appl. No.: 19/087,904

(22) Filed: Mar. 24, 2025

(51) Int. Cl. G06Q 10/0631

(52) U.S. Cl. CPC G06Q 10/06316

(57) ABSTRACT

A method for generating workflows includes obtaining domain knowledge associated with an entity. The method includes generating a representation of the domain knowledge. After generating the representation, the method also includes obtaining, from a requestor associated with the entity, a request to generate a workflow including a plurality of tasks. The method includes obtaining, using the representation, contextual information associated with the workflow. The method also includes generating, based on the contextual information, the workflow.

### TECHNICAL FIELD

This disclosure relates to personalized text-to-action with domain knowledge.

### BACKGROUND

Low-code/no-code environments have revolutionized the way businesses develop and deploy software applications by enabling users with minimal programming knowledge to create functional applications through intuitive graphical interfaces. These platforms significantly reduce the time and cost associated with traditional software development, allowing organizations to quickly adapt to changing business needs. By leveraging pre-built components and drag-and-drop functionalities, low-code/no-code environments empower a broader range of users, including business analysts and other non-technical staff, to participate in the application development process. This democratization of software development not only accelerates innovation but also enhances collaboration across different departments within an organization.

One of the many applications of low-code/no-code environments is the generation of workflows, which are sequences of automated actions designed to streamline business processes. These workflows can range from simple task automation to complex multi-step processes involving various systems and data sources. By converting natural language text into executable workflows, these platforms enable users to automate repetitive tasks, improve efficiency, and ensure consistency in business operations. However, the workflows generated by these environments are often generic and lack personalization, failing to account for specific company standards, best practices, and individual user preferences.

### SUMMARY

One aspect of the disclosure provides a method for generating workflows using domain knowledge. The method includes obtaining domain knowledge associated with an entity and generating a representation of the domain knowledge. The method also includes, after generating the representation, obtaining, from a requestor associated with the entity, a request to generate a workflow including a plurality of tasks. The method includes obtaining, using the representation, contextual information associated with the workflow. The method also includes generating, based on the contextual information, the workflow.

Implementations of the disclosure may include one or more of the following optional features. In some implementations, the method further includes executing the workflow. At least one of the plurality of tasks may include accessing a database. The domain knowledge, in some examples, includes at least one of knowledge articles, training documents, or previously generated workflows.

In some examples, the representation includes a JavaScript Object Notation (JSON) representation. In some of these examples, obtaining the contextual information includes mapping text from the request to a portion of the JSON representation. The portion of the JSON representation represents a previously generated workflow.

In some implementations, obtaining the contextual information includes determining, using a retrieval model, the contextual information via retrieval-augmented generation (RAG). Generating the workflow may include generating a prompt including the contextual information and providing the prompt to a large language model (LLM). In some implementations, the request includes a natural language description of the workflow.

The method may further include, after generating the workflow, obtaining, from the requestor, feedback associated with the generated workflow. Based on the feedback, the method may further include obtaining additional contextual information. In some of these examples, the method also further includes generating, based on the additional contextual information, a second workflow.

Obtaining the contextual information, in some examples, includes determining a limit and determining, using the representation, a quantity of previously generated workflows, the quantity equal to the limit. In some of these examples, the limit is based on at least one of available computational resources or feedback from the requestor.

Another aspect of the disclosure provides a system for generating workflows using domain knowledge. The system includes data processing hardware and memory hardware in communication with the data processing hardware. The memory hardware stores instructions that when executed on the data processing hardware cause the data processing hardware to perform operations. The operations include obtaining domain knowledge associated with an entity and generating a representation of the domain knowledge. The operations also include, after generating the representation, obtaining, from a requestor associated with the entity, a request to generate a workflow including a plurality of tasks. The operations include obtaining, using the representation, contextual information associated with the workflow. The operations also include generating, based on the contextual information, the workflow.

This aspect may include one or more of the following optional features. In some implementations, the operations further include executing the workflow. At least one of the plurality of tasks may include accessing a database. The domain knowledge, in some examples, includes at least one of knowledge articles, training documents, or previously generated workflows.

In some examples, the representation includes a JavaScript Object Notation (JSON) representation. In some of these examples, obtaining the contextual information includes mapping text from the request to a portion of the JSON representation. The portion of the JSON representation represents a previously generated workflow.

In some implementations, obtaining the contextual information includes determining, using a retrieval model, the contextual information via retrieval-augmented generation (RAG). Generating the workflow may include generating a prompt including the contextual information and providing the prompt to a large language model (LLM). In some implementations, the request includes a natural language description of the workflow.

The operations may further include, after generating the workflow, obtaining, from the requestor, feedback associated with the generated workflow. Based on the feedback, the operations may further include obtaining additional contextual information. In some of these examples, the operations also further include generating, based on the additional contextual information, a second workflow.

Obtaining the contextual information, in some examples, includes determining a limit and determining, using the representation, a quantity of previously generated workflows, the quantity equal to the limit. In some of these examples, the limit is based on at least one of available computational resources or feedback from the requestor.

Another embodiment of the disclosure provides a computer-readable medium having instructions that, when executed by data processing hardware, causes the data processing hardware to perform operations. The operations include obtaining domain knowledge associated with an entity and generating a representation of the domain knowledge. The operations also include, after generating the representation, obtaining, from a requestor associated with the entity, a request to generate a workflow including a plurality of tasks. The operations include obtaining, using the representation, contextual information associated with the workflow. The operations also include generating, based on the contextual information, the workflow.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for generating workflows using domain knowledge.

FIG. 2 is a schematic view of a retrieval model for the system of FIG. 1.

FIG. 3 is a schematic view of a prompt generator 310 for the system of FIG. 1.

FIG. 4 is a flowchart of an example arrangement of operations for a method of generating a workflow.

FIG. 5 is a schematic view of an example computing device that may be used to implement the systems and methods described herein.

Like reference symbols in the various drawings indicate like elements.

### DETAILED DESCRIPTION

Managing workflows in enterprise environments is a complex task that requires adherence to company standards, best practices, and individual preferences.

Traditional methods for generating workflows often fall short in providing the necessary personalization and context-awareness. These methods typically rely on generic templates or rule-based systems that do not account for the specific business environment, terminology, or individual styles of different users. As a result, the generated workflows may be overly simplified and fail to meet the unique needs of each organization, leading to inefficiencies and reduced effectiveness.

One significant challenge is the need for workflows to reflect company standards and best practices. Organizations often have specific guidelines and architectural frameworks that must be followed to ensure consistency and compliance. However, existing workflow generation tools often lack the capability to incorporate this tribal knowledge, resulting in workflows that do not align with the organization's established procedures. This misalignment can lead to errors, increased training costs, and a lack of trust in the automated systems.

Another challenge is the need for workflows to be context-aware. Different organizations use different terminologies and have unique business environments that must be understood to generate relevant workflows. Traditional methods do not have the capability to understand and integrate this context, leading to workflows that are not tailored to the specific needs of the organization. This lack of personalization can result in workflows that are not only less effective but also more difficult for users to adopt and utilize.

Implementations herein address these challenges by providing systems and methods for generating personalized and context-aware workflows. A workflow generator begins by obtaining domain knowledge associated with an entity (e.g., a specific user, department, company, business, etc.), which includes company standards, best practices, and individual preferences. This domain knowledge is then used to generate a representation that serves as a foundation for the workflow generation process.

Once the representation is generated, the workflow generator obtains a request from a requestor associated with the entity to generate a workflow. Using the representation, the workflow generator obtains contextual information associated with the workflow from the representation. This contextual information ensures that the generated workflow is aligned with the specific standards and/or preferences of the entity.

Based on the contextual information, the workflow generator generates the workflow, ensuring that the workflow, for example, adheres to company standards, best practices, and/or individual preferences. Thus, the workflow generator may leverage techniques such as Retrieval-Augmented Generation (RAG) to integrate tribal knowledge into the workflow generation process, enhancing the relevance and usefulness of the workflows. Optionally, the workflow generator includes a feedback loop that receives feedback from the requestor. Based on the feedback, the workflow may be regenerated or adjusted using additional or different contextual information. In some examples, the workflow generator compares the generated workflow to existing templates using similarity scores. This feedback may be used to continuously improve the model(s) used in the process.

These implementations offer several advantages. By incorporating domain knowledge and contextual information, the generated workflows are more personalized and relevant to the specific needs of the organization. This personalization avoids the over-simplification seen in traditional techniques and ensures that the workflows are aligned with standards and/or preferences. Additionally, the use of RAG and fine-tuning/few-shot learning enhances the quality and effectiveness of the workflows. This reduces the computational overhead associated with generating and refining workflows, as the system can more efficiently retrieve and integrate pertinent tribal knowledge and contextual information without having the user search for information or refine the workflow manually. Moreover, the feedback loop ensures continuous improvement. The workflow generator also reduces the need for manual input and resource wastage, making the workflow generation process more efficient and scalable. Consequently, the workflow generator not only streamlines the workflow generation process but also optimizes resource utilization, leading to faster and more reliable execution of tasks within enterprise environments.

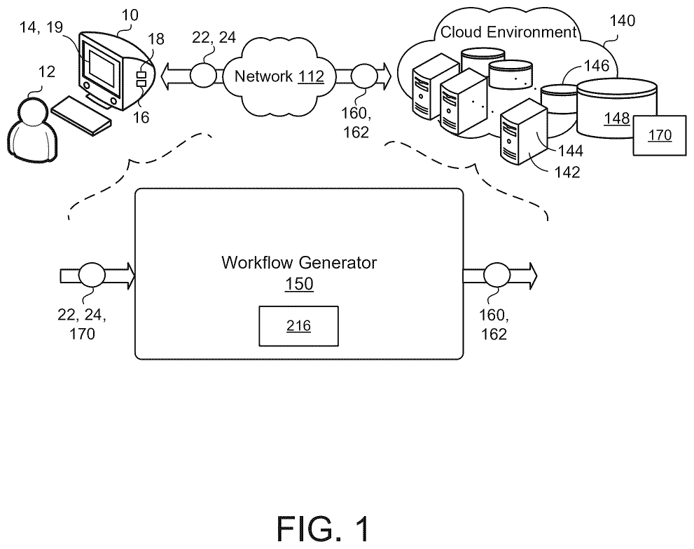

Referring to FIG. 1, in some implementations, a workflow generation system 100 may include a remote system 140 in communication with one or more user devices 10 each associated with a respective user 12 via a network 112, such as the Internet, a local area network (LAN), a wide area network (WAN), a cellular network, or a wireless network. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 148 (i.e., a remote storage device) may be overlain on the storage resources 146 to allow scalable use of the storage resources 146 by one or more of the clients (e.g., the user device 10) or the computing resources 144.

The remote system 140 is configured to communicate with the user device 10 via, for example, the network 112. The user device(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 19 for display on a screen 14 in communication with the data processing hardware 18.

The remote system 140 may execute a workflow generator 150 that the user device 10 communicates with via the network 112. The workflow generator 150 is a software application or module that is configured to generate workflows 160.

As used herein, a workflow 160 is a series of automated actions or tasks 162 designed to achieve a specific outcome or goal. Workflows 160 provide a structured and repeatable approach to processes, ensuring consistency and efficiency. Workflows 160 generally consist of interconnected steps, including tasks 162, decisions, and/or transitions, that are executed in a predefined sequence. Workflows 160 may be triggered by various events, such as user input, system events, or scheduled times, and can involve human interaction or be fully automated.

Examples of workflows 160 include, but are not limited to: a customer onboarding workflow that automates the steps involved in setting up a new customer account, including data entry, verification, and welcome email generation; an order fulfillment workflow that manages the process of receiving, processing, and shipping customer orders, including inventory checks, payment processing, and shipment tracking; an incident management workflow that automates the steps involved in resolving IT incidents, including ticket creation, assignment, resolution, and closure; and a content approval workflow that manages the process of reviewing and approving content before publication, including submission, review, feedback, and approval steps. These examples illustrate the breadth of applications for workflows and their potential to streamline and automate complex processes. The tasks 162 within a workflow 160 may involve various operations, including, but not limited to, database manipulations (reads, writes, updates), API calls to external services, data transformations, conditional logic based on data values, user notifications, interactions with other workflows, etc.

The workflow generator 150 obtains domain knowledge 170 associated with an entity. The domain knowledge 170 may include any type of information that is relevant to the entity, such as company standards, best practices, individual preferences, or other tribal knowledge. The entity may be a user 12 or other individual, a business, an organization, a department, a user group, etc. In some examples, the domain knowledge 170 may be obtained from a knowledge base, a document repository, or another source of information. In some examples, the domain knowledge 170 is stored at the data store 148. Additionally or alternatively, the workflow generator 150 obtains the domain knowledge 170 from other sources, such as the user 12 or a third party source. Using the domain knowledge, the workflow generator 150 generates a representation 216 of the domain knowledge. The representation 216 may be in any format that is suitable for use by the workflow generator 150, such as a JavaScript Object Notation (JSON) object.

In some implementations, the domain knowledge 170, whether sourced from a knowledge base, document repository, user input, or third-party sources, undergoes a structured indexing process in order to generate the representation 216. This indexing facilitates efficient retrieval and utilization of the domain knowledge during workflow generation. For instance, when the domain knowledge 170 includes company standards documents, these documents may be parsed and key terms, concepts, and procedures extracted. These extracted elements are then organized and structured, potentially using a hierarchical format, to reflect the relationships between different pieces of information.

For example, a standard regarding “Data Security” might have sub-sections on “Access Control,” “Encryption,” and “Data Retention.” Each of these sub-sections may be further broken down into specific rules and guidelines. This structured information is then encoded into a machine-readable format, such as a JSON object.

The JSON object optionally include fields for categories (e.g., “Company Standards,” “Best Practices,” “User Preferences”), sub-categories (e.g., “Data Security,” “Project Management,” “Communication Protocols”), and specific entries containing the actual knowledge (e.g., “All passwords must be at least 12 characters long and include a mix of uppercase and lowercase letters, numbers, and symbols”). User preferences may be handled similarly, with fields for preferred tools, communication styles, task prioritization methods, etc.

Previously generated workflows 160 (i.e., workflows generated by the remote system 140, provided by the user 12, retrieved from third-party sources, etc.) may be indexed into a JSON format to facilitate their retrieval and reuse. Each workflow 160 may be represented as a JSON object with fields for its name, description, the tasks it comprises, the order of those tasks, any conditions or branching logic involved, and the resources or data it interacts with. For example, a “Content Approval Workflow” might have tasks like “Submit Content,” “Review Content,” “Provide Feedback,” and “Approve/Reject.” The JSON object may capture these tasks, their sequence, and any associated data, such as the content being reviewed or the reviewers assigned. This structured representation allows the workflow generator 150 to easily search for and retrieve relevant workflows 160 based on requests 22 or contextual information 220.

The indexing process may also involve assigning weights or scores to different pieces of knowledge based on their importance or relevance. This allows the workflow generator 150 to prioritize certain aspects of the domain knowledge 170 during workflow generation. The resulting indexed and structured domain knowledge 170, represented as a JSON object (or other suitable data structure), may be the foundation for generating the representation 216.

After generating the representation 216, the workflow generator 150, in some examples, receives a request 22, from a requestor (e.g., a user 12) associated with the entity, to generate a workflow 160 that includes one or more tasks 162. The request 22 may be in any format that is suitable for use by the workflow generator 150, such as a natural language description of the workflow 160. The workflow generator 150 obtains or determines, using the representation, 216, contextual information 220 associated with the workflow 160. The contextual information 220 may include any information that is relevant to the workflow 160, such as the type of workflow 160, the tasks 162 to be included in the workflow 160, or the order in which the tasks 162 are to be performed.

Based on the contextual information 220, the workflow generator 150 generates or creates the workflow 160.

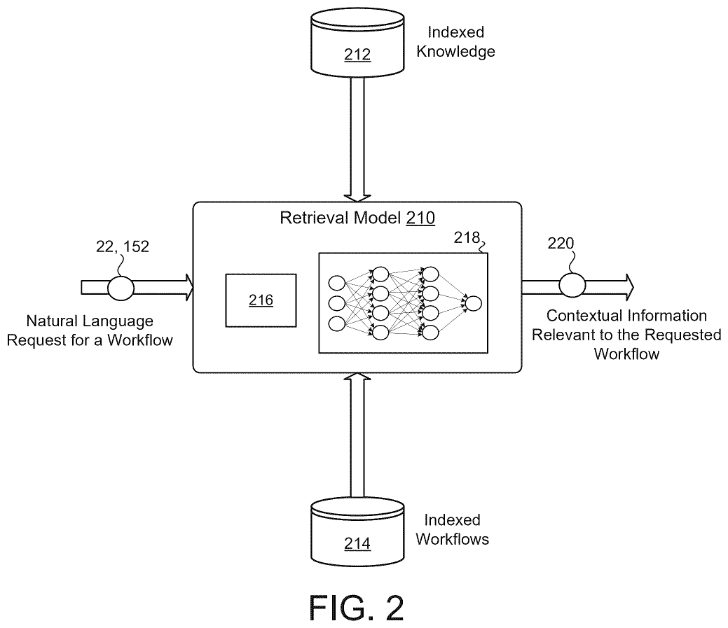

Referring now to FIG. 2, in some examples, the workflow generator 150 includes a retrieval model 210 to obtain or generate or determine the contextual information 220. In some examples, the retrieval model 210 receives or obtains the representation 216 (e.g., from the workflow generator 150). In other examples, the retrieval model 210 first generates the representation 216 from indexed knowledge 212 (e.g., knowledge passages and articles) and/or indexed workflows 214 derived from the domain knowledge 170 (FIG. 1). In some implementations, the retrieval model 210 uses retrieval-augmented generation (RAG) or other techniques to retrieve or otherwise obtain the contextual information 220 from one or more data sources (e.g., the data store 148).

In some examples, the retrieval model 210 implements two applications of retrieval-augmented generation (RAG) to obtain the contextual information 220. First, the retrieval model 210 retrieves the indexed knowledge 212 associated with requirements or preferences of the entity (e.g., the user 12). This knowledge 212 can be derived from various sources, such as knowledge articles, training documents, user profiles, or past interactions. This process is analogous to a passage-retrieval pipeline: given a corpus of documents, the retrieval model 210 identifies the passages that are most relevant to an input text, such as the user's request 22. For instance, if the user requests a “content approval workflow,” the retrieval model 210 might retrieve passages from training documents that describe the company's content approval process, relevant policies, or best practices for content review. These retrieved passages provide context for the workflow generation process.

Second, the retrieval model 210 additionally or alternatively retrieves the indexed workflows 214 related to pertinent workflows 160 previously generated (by the remote system 140 or elsewhere). This allows the workflow generator 150 to leverage existing workflows 160 as templates or examples, adapting them to the current user's request 22. For this purpose, the retrieval model 210 may be fine-tuned to learn to map workflows 160 in JSON format to text descriptions. Specifically, the retrieval model 210 is trained to create an embedding space where JSON structures of workflows 160 are mapped close to related text descriptions, using positive and negative pairs for training.

The retrieval model may include any suitable model 218 for training, such as a transformer-based model, a latent Dirichlet allocation (LDA) model, or a support vector machine (SVM) model. In some examples, the retrieval model 210 includes a transformer-based model 218. Transformer-based models are particularly well-suited for natural language processing tasks and are capable of generating high-quality embeddings that capture the meaning of text. In some examples, the model 218 is fine-tuned, which may involve training the model 218 on a smaller dataset that is specific to the task at hand. In the case of workflow generation, the fine-tuning dataset may include examples of workflows and their corresponding text descriptions. This allows the model 218 to learn to map workflows to text description to accurately retrieve relevant workflows 214 from the representation 216.

Positive pairs consist of a workflow 160 in JSON format and its corresponding text description, while negative pairs consist of a workflow 160 and an unrelated text description. This training enables the retrieval model 210 to efficiently find previously generated workflows that are similar to the current request 22, even if the request is expressed in natural language. For example, if a request 22 requests a workflow 160 for “onboarding a new employee,” the retrieval model 210 may retrieve a previously generated workflow for “new hire onboarding” from the data store 148 (or other data source), along with its associated text description. This retrieved workflow 160 can then be adapted and personalized to meet the specific needs of the current request 22 (e.g., based on the user requirements and/or preferences derived from the domain knowledge 170 and/or contextual information 220). Thus, the retrieval model 210 may employ various architectures, such as transformer-based models, and can be trained using techniques like contrastive learning to optimize the mapping between workflows and their textual representations.

In some examples, the request 22 itself further enriches the contextual information 220. For example, the request 22 may include attachments, links to articles, or other knowledge resources provided by the user 12. The retrieval model 210 may process these additional resources, extracting key information and incorporating it into the indexed knowledge 212. This allows the workflow generator 150 to consider the specific knowledge and information explicitly provided by the user 12 in the current request 22, ensuring that the generated workflow 160 is highly relevant to the user's immediate needs. For instance, if the user 12 attaches an article describing a new company policy, the retrieval model 210 may parse the article, identify the key policy points, and integrate them into the indexed knowledge 212 related to company standards. This dynamically updates the contextual information 220 with the user's provided knowledge, making the workflow generation process more responsive and accurate.

Additionally or alternatively, the request 22 may include one or more workflows that the retrieval model 210 considers along with the indexed workflows 214. For instance, a request 22 may include a previously generated workflow that the requestor wishes to modify or adapt. The retrieval model 210 analyzes this provided workflow, extracting its structure, tasks, and logic. This information is then considered alongside the indexed workflows 214, allowing the retrieval model 210 to identify similar workflows and leverage their components. The retrieval model 210 may employ techniques such as graph matching or workflow similarity analysis to compare the provided workflow with the indexed workflows 214. This enables the workflow generator 150 to incorporate relevant elements from existing workflows, promoting reuse and consistency. In some examples, the retrieval model 210 may identify conflicts or inconsistencies between the provided workflow and the indexed workflows 214, providing feedback to the requestor or automatically resolving the conflicts based on predefined rules or preferences.

Referring back to FIG. 1, after generating a workflow 160 based on a request 22, the workflow generator 150 may receive feedback 24 from the user 12 associated with the generated workflow 160. This feedback 24 may be explicit, such as the user 12 providing a rating or comment on the workflow 160, or implicit, such as the user 12 modifying the workflow 160 or choosing not to use the workflow 160. The workflow generator 150 may collect and analyze this feedback 24 to identify areas for improvement in the workflow generation process. For example, if the user 12 frequently modifies certain types of workflows 160, the workflow generator 150 may infer that the initial versions of these workflows 160 are not adequately meeting the user's needs.

Based on the feedback 24, the retrieval model 210 may obtain additional or different contextual information 220 that may be used to generate a new or updated workflow 160. For instance, if the user 12 provides feedback 24 that a generated workflow 160 is missing a particular task 162, the retrieval model 210 may search for indexed knowledge 212 related to that task 162 and incorporate it into the contextual information 220. Alternatively, if the user 12 modifies the workflow 160 to change the order of tasks 162, the retrieval model 210 may analyze the modified workflow 160 and update the indexed workflows 214 to reflect this change. This feedback loop allows the workflow generator 150 to continuously learn and improve, generating workflows 160 that are increasingly tailored to the needs and preferences of the users 12.

Referring again to FIG. 2, in some implementations, the workflow generator 150 determines and imposes a limit 152 on the amount of contextual information 220 obtained by the retrieval model 210 and/or used to generate the workflow 160. This limit 152 may be based on factors such as available computational resources (e.g., resources available to the remote system 140) and the feedback 24 (FIG. 1) from the user 12. For example, the workflow generator 150 may monitor the computational resources 144 available at the remote system 140, such as processing power and memory usage. If the computational resources 144 are nearing capacity, the workflow generator 150 may reduce the amount of contextual information 220 used to generate the workflow 160. This reduction may involve limiting the number of indexed workflows 214 considered, the amount of indexed knowledge 212 (e.g., a number of knowledge passages), or the depth of analysis performed on the request 22 and associated knowledge resources. By limiting the contextual information 220, the workflow generator 150 reduces the computational load and prevents the workflow generation process from consuming excessive resources.

The limit 152 on the contextual information 220 may also be dynamically adjusted based on the feedback 24 from the user 12. When the user 12 provides feedback 24 indicating a generated workflow 160 was unsatisfactory, the workflow generator 150 may adjust the limit 152. For instance, if the user 12 provides feedback 24 suggesting the workflow 160 lacked certain features or did not adequately address their needs, the workflow generator 150 may increase the limit 152. This increase allows the retrieval model 210 to consider a broader range of contextual information 220, potentially including additional indexed workflows 214 or indexed knowledge 212 that were previously excluded. Conversely, if the user 12 provides feedback 24 indicating the workflow 160 was overly complex or included unnecessary steps, the workflow generator 150 may decrease the limit 152. This decrease encourages the retrieval model 210 to focus on the most relevant contextual information 220 and avoid incorporating extraneous details. By dynamically adjusting the limit 152 based on the feedback 24, the workflow generator 150 optimizes the balance between the richness of the contextual information 220 and the efficiency of the workflow generation process.

In some implementations, the workflow generator 150 dynamically adjusts the limit 152 on the number of passages and/or workflows (i.e., the indexed knowledge 212 and/or indexed workflows 214) based on quality and latency requirements. For example, if a high level of quality is required for a particular workflow (e.g., based on a parameter received with the request 22), the workflow generator 150 may increase the limit 152 to allow the retrieval model 210 to consider a wider range of contextual information 220.

This may result in a longer processing time, but it also increases the likelihood that the generated workflow 160 will be accurate and comprehensive. Conversely, if a fast response time is critical, the workflow generator 150 may decrease the limit 152 to reduce the amount of contextual information 220 processed, which can lead to faster workflow generation but may also potentially impact the quality of the generated workflow 160. This dynamic adjustment allows the workflow generator 150 to balance the trade-off between quality and latency, ensuring that workflows 160 are generated efficiently while meeting the specific requirements of each request 22. For example, a workflow 160 for a critical customer support issue may need to be generated quickly, even if it means sacrificing some quality in terms of detail or accuracy. On the other hand, a workflow 160 for a complex business process may require a higher level of quality, even if it takes longer to generate. The requestor (e.g., a user 12) may indicate a quality and/or latency requirement along with the request 22.

Following the generation of the workflow 160 by the LLM 330, the workflow generator 150 may implement a post-processing stage to refine and validate the output.

This stage optionally includes comparing the generated workflow 160 to existing templates or previously generated workflows using a flow similarity API. The flow similarity API computes similarity scores based on various factors, such as the sequence of tasks 162, the types of tasks 162, the data flow, and the control flow within the workflows. These similarity scores provide a quantitative measure of how closely the generated workflow 160 matches existing workflows. High similarity scores may indicate that the generated workflow 160 aligns well with established best practices or company standards, while low scores may suggest deviations that require further review or adjustment. This comparison allows for the identification of potential errors, inconsistencies, or areas for optimization in the generated workflow 160. For instance, if the flow similarity API reveals that the generated workflow 160 deviates significantly (e.g., by more than a threshold amount) from a standard template for a particular process, the workflow generator 150 may flag this deviation for review (e.g., by a user 12 or other administrator) or automatically adjust the workflow 160 to align with the template.

The workflow generator 150, in some implementations, feeds the similarity scores generated by the flow similarity API, along with other feedback 24 from the user 12, back into the system to improve the retrieval model 210 and/or the LLM 330. For the retrieval model 210, the workflow generator may use the similarity scores to refine the indexing and retrieval of relevant contextual information 220. For example, if a generated workflow 160 with a low similarity score is subsequently modified by the user 12, the retrieval model 210 may analyze the modifications and update the indexed knowledge 212 and indexed workflows 214 to better reflect the user's preferences and requirements. Similarly, the workflow generator 150 may fine-tune the LLM 330 using the feedback 24 and similarity scores to improve the ability of the LLM 330 to generate workflows 160 that align with existing templates and best practices. For instance, the LLM 330 may be trained on a dataset that includes generated workflows 160, their corresponding similarity scores, and any user modifications. This training allows the LLM 330 to learn to generate workflows 160 that not only satisfy user requests 22 but also adhere to established standards and preferences, thereby reducing the need for manual post-processing and ensuring higher quality workflows 160.

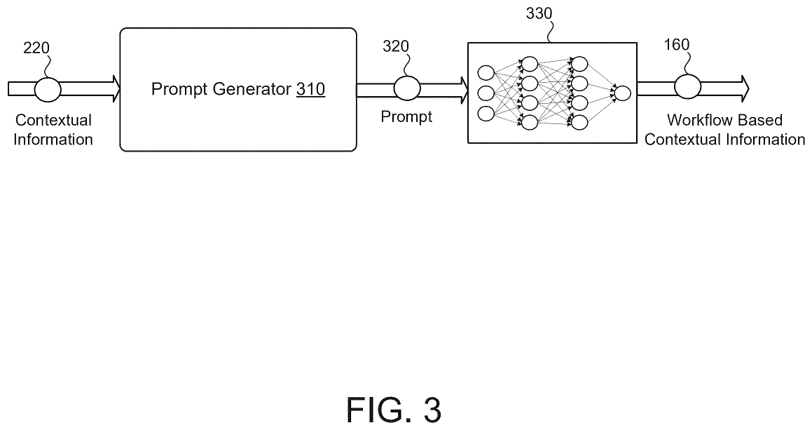

Referring now to FIG. 3, in some implementations, the workflow generator 150 includes a prompt generator 310 and a model, such as a large language model (LLM) 330. The prompt generator 310 receives the contextual information 220 from the retrieval model 210. This contextual information 220, as discussed previously, may include retrieved knowledge related to the entity's requirements and preferences (e.g., indexed knowledge 212) and/or previously generated, similar workflows (e.g., indexed workflows 214). The prompt generator 310 uses this contextual information 220 to construct a prompt 320 for the LLM 330. The quantity or amount of contextual information 220 provided in the prompt 330 may be based on the limit 152. The prompt 320 is crafted to guide the LLM 330 in generating the desired workflow 160. The prompt 320 may include specific instructions, constraints, examples of similar workflows, and/or relevant domain knowledge extracted from the contextual information 220. For example, the prompt 320 might specify the type of workflow requested (e.g., “content approval”), the required tasks 162, the order of those tasks, any necessary approvals, and any company-specific terminology or procedures.

The LLM 330, upon receiving the prompt 320, generates the workflow 160 (or a representation thereof) for the request 22. The LLM 330 leverages its extensive training data and natural language processing capabilities to interpret the prompt 320 and generate a workflow 160 that satisfies the specified requirements and adheres to the provided context. The generated workflow 160 may be in a structured format, such as JSON or YAML, suitable for execution by a workflow engine. In some implementations, the LLM 330 may generate a high-level representation of the workflow 160, which is then further processed or refined by other components of the workflow generator 150 before execution. The LLM's 330 ability to understand natural language and generate structured output makes it well-suited for this task, enabling the creation of complex and personalized workflows based on user requests 22 and contextual information 220.

In some implementations, the LLM 330 undergoes fine-tuning to enhance its performance in generating workflows 160. This fine-tuning process involves training the LLM 330 on a dataset specifically curated for workflow generation. The training data may include examples of workflows 160 paired with their corresponding requests 22 and contextual information 220. This allows the LLM 330 to learn the relationships between user requests 22, contextual information 220, and the resulting workflows 160. For example, the training dataset may include a request 22 such as “Create a workflow for onboarding a new marketing employee,” along with contextual information 220 including company standards for new hire onboarding and previously generated marketing team onboarding workflows. The corresponding workflow 160 in the training data would then detail the specific tasks 162 involved in onboarding a new marketing employee, such as setting up access to tools, curating training material, and assigning initial projects.

In some examples, the LLM 330 is fine-tuned in a few-shot learning paradigm. Few-shot learning involves training the LLM 330 on a small number of examples, enabling it to generalize to new, unseen scenarios. In the context of workflow generation, few-shot learning allows the LLM 330 to generate workflows 160 for a wide range of requests 22, even with limited training data. For example, the LLM 330 may be fine-tuned with a few examples of content approval workflows, each paired with its request 22 and contextual information 220. These examples might include different content types (e.g., blog posts, marketing brochures, website copy) and varying approval processes. After fine-tuning, the LLM 330 may generate a content approval workflow for a new content type, such as a video script, even though it was not explicitly trained on video script approvals. The few-shot learning approach enables the LLM 330 to adapt to new workflow types and requirements with minimal additional training, making the workflow generation process more efficient and scalable.

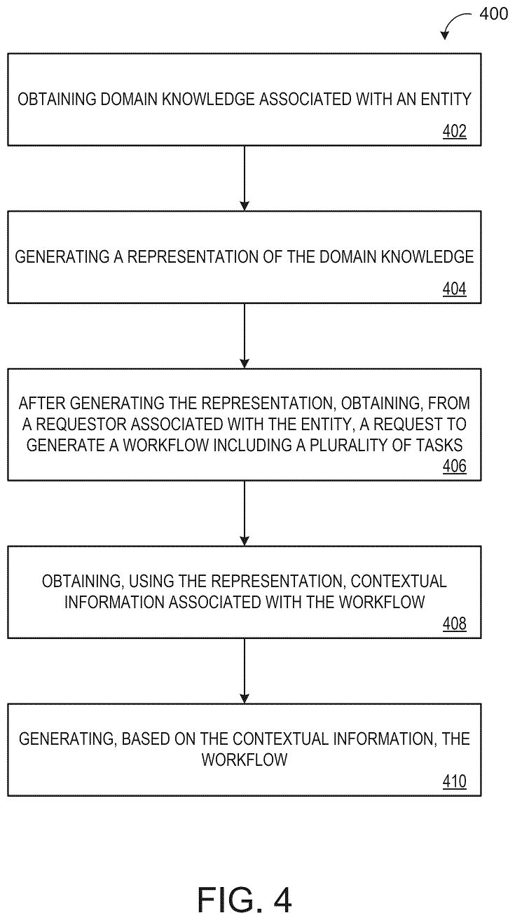

FIG. 4 is a flowchart of an exemplary arrangement of operations for a method 400 of generating workflows 160. The method 400, at step 402, includes obtaining domain knowledge 170 associated with an entity and, at step 404, generating a representation 216 of the domain knowledge 170. The method 400, at step 406, also includes, after generating the representation 216, obtaining, from a requestor (e.g., the user 12) associated with the entity, a request 22 to generate a workflow 160 including a plurality of tasks 162. The method 400, at step 408, includes obtaining, using the representation 216, contextual information 220 associated with the workflow 160. The method 400, at step 410, also includes generating, based on the contextual information 220, the workflow 160.

This arrangement, in which a workflow 160 is generated based on domain knowledge 170 and a related request 22, provides numerous technical advantages. For example, by obtaining domain knowledge 170 and generating a representation 216 of the domain knowledge 170, the generated workflow 160 may better conform to company standards, best practices, and individual preferences. This contrasts with traditional methods for generating workflows, which often do not account for the specific business environment, terminology, or individual styles of different users, as discussed previously. Obtaining a request 22 from a requestor associated with the entity and obtaining contextual information 220 associated with the workflow 160 further enhances the relevance and personalization of the generated workflow 160, ensuring it aligns with the specific needs and context of the user and organization. By generating the workflow 160 based on this contextual information 220, the method 400 addresses the challenges of incorporating tribal knowledge and ensuring context-awareness.

Moreover, the method 400 (and similarly the system 100) offers several additional technical benefits, such as improved efficiency, scalability, and resource utilization. By automating the workflow generation process, the method 400 reduces the need for manual input and resource wastage. The use of domain knowledge 170 and contextual information 220 also avoids over-simplification and ensures that the workflows 160 are aligned with standards and/or preferences, leading to faster and more reliable execution of tasks within enterprise environments. Furthermore, the feedback loop and continuous improvement mechanisms enhance the quality and effectiveness of the workflows 160 over time. Overall, the methods and systems described herein provide a robust and adaptable solution for generating personalized and context-aware workflows 160 that meet the unique needs of organizations and individuals, addressing the limitations of traditional workflow generation techniques.

Additionally, the systems and methods described herein represent an advancement over other technical alternatives, offering a more efficient, cost-effective, and user-friendly approach to generating personalized and context-aware workflows. For example, instead of fine-tuning an LLM for each instance, which is computationally expensive and requires specialized infrastructure, implementations herein leverage RAG to achieve instance-awareness without the need for repeated fine-tuning. This not only reduces the computational overhead but also makes the system more adaptable and scalable. Additionally, compared to the alternative of requiring users to manually supply all relevant knowledge and workflows, implementations herein automate the process of obtaining and integrating contextual information, saving users time and effort.

Furthermore, while a very large generic LLM may be used, such an LLM would be more costly and less effective than the smaller, fine-tuned LLM described herein, which has specialized knowledge of workflows and their applications.

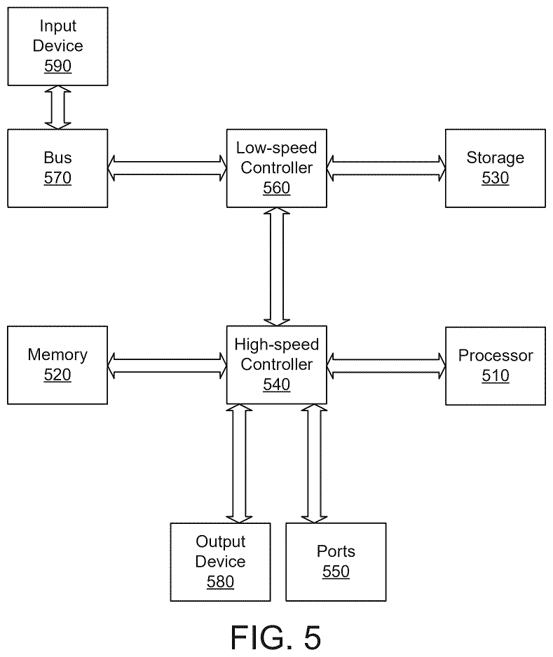

FIG. 5 is a schematic view of an example computing device 500 that may be used to implement the systems and methods described in this document. The computing device 500 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can execute instructions for performing operations within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server cluster, a group of blade servers, or a multi-processor system).

The memory 520 stores information within the computing device 500. The memory 520 may be a non-transitory computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs).

Examples of volatile memory include, but are not limited to, random access memory (RAM), dynamic random-access memory (DRAM), static random-access memory (SRAM), phase change memory (PCM) as well as disks or tapes.

The storage device 530 is capable of providing mass storage for the computing device 500. In some implementations, the storage device 530 is a non-transitory computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port or input device 590. The low-speed expansion port 590, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 500 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining domain knowledge associated with an entity;
generating a representation of the domain knowledge;
after generating the representation, obtaining, from a requestor associated with the entity, a request to generate a workflow comprising a plurality of tasks;
obtaining, using the representation, contextual information associated with the workflow; and
generating, based on the contextual information, the workflow.

2. The method of claim 1, further comprising executing the workflow.

3. The method of claim 1, wherein at least one of the plurality of tasks comprises accessing a database.

4. The method of claim 1, wherein the domain knowledge comprises at least one of:
knowledge articles;
training documents; or
previously generated workflows.

5. The method of claim 1, wherein the representation comprises a JavaScript Object Notation (JSON) representation.

6. The method of claim 5, wherein obtaining the contextual information comprises mapping text from the request to a portion of the JSON representation, the portion of the JSON representation representing a previously generated workflow.

7. The method of claim 1, wherein obtaining the contextual information comprises determining, using a retrieval model, the contextual information via retrieval-augmented generation (RAG).

8. The method of claim 1, wherein generating the workflow comprises:
generating a prompt comprising the contextual information; and
providing the prompt to a large language model (LLM).

9. The method of claim 1, wherein the request comprises a natural language description of the workflow.

10. The method of claim 1, further comprising, after generating the workflow:
obtaining, from the requestor, feedback associated with the generated workflow;
based on the feedback, obtaining additional contextual information; and
generating, based on the additional contextual information, a second workflow.

11. The method of claim 1, wherein obtaining the contextual information comprises:
determining a limit; and
determining, using the representation, a quantity of previously generated workflows, the quantity equal to the limit.

12. The method of claim 11, wherein the limit is based on at least one of:
available computational resources; or feedback from the requestor.

13. A system comprising:
data processing hardware; and
memory hardware in communication with the data processing hardware, the memory hardware storing instructions that when executed on the data processing hardware cause the data processing hardware to perform operations comprising:
obtaining domain knowledge associated with an entity;
generating a representation of the domain knowledge;
after generating the representation, obtaining, from a requestor associated with the entity, a request to generate a workflow comprising a plurality of tasks;
obtaining, using the representation, contextual information associated with the workflow; and
generating, based on the contextual information, the workflow.

14. The system of claim 13, further comprising executing the workflow.

15. The system of claim 13, wherein at least one of the plurality of tasks comprises accessing a database.

16. The system of claim 13, wherein the domain knowledge comprises at least one of:
knowledge articles;
training documents; or
previously generated workflows.

17. The system of claim 13, wherein the representation comprises a JavaScript Object Notation (JSON) representation.

18. The system of claim 17, wherein obtaining the contextual information comprises mapping text from the request to a portion of the JSON representation, the portion of the JSON representation representing a previously generated workflow.

19. The system of claim 13, wherein obtaining the contextual information comprises determining, using a retrieval model, the contextual information via retrieval-augmented generation (RAG).

20. A computer-readable medium having instructions that, when executed by data processing hardware, causes the data processing hardware to perform operations comprising:
obtaining domain knowledge associated with an entity;
generating a representation of the domain knowledge;
after generating the representation, obtaining, from a requestor associated with the entity, a request to generate a workflow comprising a plurality of tasks;
obtaining, using the representation, contextual information associated with the workflow; and
generating, based on the contextual information, the workflow.
